(19) United States
(12) Patent Application Publication
(10) Pub. No.: US 2012/0120152 A1
(43) Pub. Date: May 17, 2012

(54) PRINTING DEVICE, PRINT HEAD, AND INK CARTRIDGE

(76) Inventors: Masami OGURA, Matsumoto-shi (JP); Naoki SUDO, Matsumoto-shi (JP); Bunji ISHIMOTO, Matsumoto (JP)

(21) Appl. No.: 13/291,452

(22) Filed: Nov. 8, 2011

(30) Foreign Application Priority Data
Nov. 16, 2010 (JP) 2010-255465

(51) Int. Cl. B41J 23/00; B41J 2/175

(52) U.S. Cl. 347/37; 347/87

(57) ABSTRACT

There is provided a printing device for carrying out printing with ink supplied from L ink cartridges in which ink of the same hue is accommodated. The printing device includes a print head with a plurality of nozzle rows spaced apart in a main scanning direction, and includes a first nozzle group of L×a nozzle rows, in which the positions of the nozzles in the sub-scanning direction are mutually the same and which receive a supply of the ink from each of the L cartridges in sets of a rows, and a second nozzle group of L×b nozzle rows, in which the positions of the nozzles in the sub-scanning direction differ from those of the nozzles of the first nozzle row and which receive a supply of the ink from each of the L cartridges in sets of b rows.

### CROSS-REFERENCE TO RELATED APPLICATIONS

This application claims priority to Japanese Patent Application No. 2010-255465 filed on Nov. 16, 2010. The entire disclosure of Japanese Patent Application No. 2010-255465 is hereby incorporated herein by reference.

### BACKGROUND

1. Technological Field

The present invention relates to a printing device, and in more detail to a printing device for carrying out printing with ink supplied from a plurality of ink cartridges in which ink of the same hue is accommodated.

2. Background Technology

In printing devices provided with a plurality of ink cartridges in which ink of the same hue is accommodated, it is desirable to minimize biased consumption (herein also termed “uneven usage”) of ink among ink cartridges. Patent Citation 1, for example, is one known technique for minimizing uneven usage.

Japanese Patent Application Publication No. 2009-113412 (Patent Citation 1) is an example of the related art.

### SUMMARY

### Problems to be Solved by the Invention

It is an advantage of the invention to provide a technique for minimizing uneven usage in a plurality of ink cartridges containing an ink of the same hue, by a different method from a well know method in the art.

### Means Used to Solve the Above-Mentioned Problems

In order to solve the above-described problem at least in part, it is possible for the invention to assume the aspects and embodiments described below.

### First Aspect

A printing device for carrying out printing upon receiving a supply of ink from L ink cartridges (L being an integer of 2 or greater) in which ink of the same hue is accommodated, wherein the printing device includes: a print head provided with a plurality of nozzle rows in which are arrayed, in a predetermined direction, a plurality of nozzles for ejecting the ink, the nozzle rows being spaced apart in a direction that intersects the predetermined direction; a head-moving section for causing the print head to move in a relative manner with respect to a printing medium in both a main scanning direction and a sub-scanning direction, the direction in which the nozzle rows are spaced apart being the main scanning direction, and the direction in which the nozzles are arrayed being the sub-scanning direction; and a controller for controlling the scanning of the print head performed by the head-moving section and the ejection of ink from the nozzles; and the printing head is provided with a first nozzle group where, among the plurality of nozzle rows, L×a nozzle rows (a being an integer of 1 or greater) in which the positions of the arrayed nozzles in the sub-scanning direction are mutually the same, and for which a predetermined correlation in printing is obtained through control by the controller, receive a supply of the ink from each of the L ink cartridges in sets of a rows; and a second nozzle group where, among the plurality of nozzle rows, L×b nozzle rows (b being an integer of 1 or greater) in which the positions of the arrayed nozzles in the sub-scanning direction differ from each nozzle of the first nozzle group receive a supply of the ink from each of the L ink cartridges in sets of b rows.

According to this printing device, biased consumption (uneven usage) of ink contained in a plurality of ink cartridges containing can be efficiently minimized.

### Second Aspect

The printing device according to the first aspect, wherein the controller carries out the control in such a manner that, of ink dots forming the entirety of a predetermined printed image, the total number of ink dots formed of ink ejected by nozzles belonging to the first nozzle group is substantially equal for every nozzle row of the a rows; and the total number of ink dots formed of ink ejected by nozzles belonging to the second nozzle group is substantially equal for every nozzle row of the b rows.

According to this printing device, uneven usage can be minimized further.

### Third Aspect

The printing device according to the first or second aspect, wherein the nozzle rows of the first nozzle group are integrally formed on a single substrate; and the nozzle rows of the second nozzle group are integrally formed on a single substrate.

According to this printing device, differences in ink ejection characteristics (ink ejection amount, ink ejection speed, and the like) due to differences between substrates do not arise among the nozzle rows of the first nozzle group. Likewise, differences in ink ejection characteristics caused by differences between substrates do not arise among the nozzle rows of the second nozzle group. Accordingly, uneven usage can be minimized further.

### Fourth Aspect

The printing device according to any of the first to third aspects, wherein the controller carries out the control in such a manner that, of ink dots forming at least part of a raster line that forms a predetermined printed image, the total number of ink dots formed of ink ejected by nozzles belonging to the first nozzle group is substantially equal for every nozzle row of the a rows.

According to this printing device, uneven usage can be minimized further. Additionally, conspicuous localized density of dot placement (banding) occurring due to inclination of the print head can be minimized.

### Fifth Aspect

The printing device according to any of the first to fourth aspects, wherein L=2, a=1, and b=1.

According to this printing device, a more compact print head is possible.

### Sixth Aspect

A print head used in the printing device of any of the first through fifth aspects for carrying out printing upon receiving a supply of ink from L ink cartridges (L being an integer of 2 or greater) in which is accommodated ink of the same hue, wherein the print head is provided with a plurality of nozzle rows in which are arrayed, in a sub-scanning direction, a plurality of nozzles for ejecting the ink, the nozzle rows being spaced apart in a main scanning direction that intersects the sub-scanning direction; among the plurality of nozzle rows, L×a nozzle rows (a being an integer of 1 or greater) in which the positions of the arrayed nozzles in the sub-scanning direction are mutually the same, and for which a predetermined correlation in printing is obtained through control by the controller, receive a supply of the ink from each of the L ink cartridges in sets of a rows; and among the plurality of nozzle rows, L×b nozzle rows (b being an integer of 1 or greater) in which the positions of the arrayed nozzles in the sub-scanning direction differ from those of the nozzles of the L×a nozzle rows receive a supply of the ink from each of the L ink cartridges in sets of b rows.

By carrying out printing with a printing device that uses this print head, uneven usage can be minimized.

### Seventh Aspect

A printing device for carrying out printing upon receiving a supply of ink from L ink cartridges (L being an integer of 2 or greater) in which ink of the same hue is accommodated, wherein the printing device includes: a print head provided with a plurality of nozzle rows in which are arrayed, in a sub-scanning direction, a plurality of nozzles for ejecting the ink, the nozzle rows being spaced apart in a main scanning direction; and a head-moving section for causing the print head to move in a relative manner with respect to a printing medium in the main scanning direction and in the sub-scanning direction; the printing head includes a first nozzle group and a second nozzle group; the first nozzle group having L×a nozzle rows (a being an integer of 1 or greater) in which the positions of the nozzles in the sub-scanning direction are mutually the same receive a supply of the ink from each of the L ink cartridges in sets of a rows; and the second nozzle group having L×b nozzle rows (b being an integer of 1 or greater) in which the positions of the nozzles in the sub-scanning direction differ from those of the nozzles of the first nozzle group, and receiving a supply of the ink from each of the L ink cartridges in sets of b rows.

### Eighth Aspect

The printing device according to the seventh aspect, wherein the printing device is characterized in that the nozzle rows of the first nozzle group are integrally formed on a single substrate; and the nozzle rows of the second nozzle group are integrally formed on a single substrate.

### Ninth Aspect

The printing device according to the seventh or eighth aspect, wherein the printing device is provided with a controller for controlling the scanning of the print head performed by the head-moving section and the ejection of ink from the nozzles; and the first nozzle group has a predetermined correlation in printing through control by the controller.

### Tenth Aspect

The printing device according to the ninth aspect, wherein the printing device is characterized in that the controller carries out the control in such a manner that, of ink dots forming the entirety of a predetermined printed image, the total number of ink dots formed of ink ejected by nozzles belonging to the first nozzle group is substantially equal for every nozzle row of the a rows; and the total number of ink dots formed of ink ejected by nozzles belonging to the second nozzle group is substantially equal for every nozzle row of the b rows.

### Eleventh Aspect

The printing device according to the ninth or tenth aspect, wherein the printing device is characterized in that the controller carries out the control in such a manner that, of ink dots forming at least part of a raster line that forms a predetermined printed image, the total number of ink dots formed of ink ejected by nozzles belonging to the first nozzle group is substantially equal for every nozzle row of the a rows.

### Twelfth Aspect

The printing device according to any of the seventh to eleventh aspects, wherein L=2, a=1, and b=1.

### Thirteenth Aspect

The printing device according to any of the seventh to twelfth aspects, wherein a nozzle pitch of the nozzle rows of the first nozzle group and a nozzle pitch of the nozzle rows of the second nozzle group are identical.

### Fourteenth Aspect

A print head provided with a plurality of nozzle rows in which are arrayed, in a sub-scanning direction, a plurality of nozzles capable of ejecting ink of the same hue, the nozzle rows being spaced apart in a main scanning direction; wherein the plurality of nozzle rows include a first nozzle group and a second nozzle group; the first nozzle group having L×a nozzle rows (L being an integer of 2 or greater, and a being an integer of 1 or greater) in which the positions of the nozzles in the sub-scanning direction are mutually the same are capable of receiving a supply of the ink from each of the L ink cartridges in sets of a rows; and the second nozzle group having L×b nozzle rows (b being an integer of 1 or greater) in which the positions of the nozzles in the sub-scanning direction differ from those of the nozzles of the first nozzle group, and receiving a supply of the ink from each of the L ink cartridges in sets of b rows.

### Fifteenth Aspect

The print head according to the fourteenth aspect, wherein the nozzle rows of the first nozzle group are integrally formed on a single substrate; and the nozzle rows of the second nozzle group are integrally formed on a single substrate.

### Sixteenth Aspect

The printing device according to the fourteenth or fifteenth aspects, wherein a nozzle pitch of the nozzle rows of the first nozzle group and a nozzle pitch of the nozzle rows of the second nozzle group are identical.

### Seventeenth Aspect

An ink cartridge of which L can be used (L being an integer of 2 or greater) in a printing device provided with a print head having a plurality of nozzle rows, wherein ink is supplied to nozzle rows of a first nozzle group among the plurality of nozzle rows; ink is supplied to nozzle rows of a second nozzle group among the plurality of nozzle rows; the first nozzle group having L×a nozzle rows (a being an integer of 1 or greater) in which the positions of the nozzles in the sub-scanning direction are mutually the same receive a supply of the ink from each of the L ink cartridges in sets of a rows; and the second nozzle group having L×b nozzle rows (b being an integer of 1 or greater) in which the positions of the nozzles in the sub-scanning direction differ from those of the nozzles of the first nozzle group, and receiving a supply of the ink from each of the L ink cartridges in sets of b rows.

### Eighteenth Aspect

The ink cartridge according to the seventeenth aspect, wherein ink of the same hue is accommodated in the L ink cartridges.

### Nineteenth Aspect

The ink cartridge according to the seventeenth or eighteenth aspect, wherein the ink cartridge is characterized in that the nozzle rows of the first nozzle group are integrally formed on a single substrate; and the nozzle rows of the second nozzle group are integrally formed on a single substrate.

### Twentieth Aspect

The ink cartridge according to any of the seventeenth to nineteenth aspects wherein a nozzle pitch of the nozzle rows of the first nozzle group and a nozzle pitch of the nozzle rows of the second nozzle group are identical.

It is possible for the invention to be realized as various embodiments. For example, the invention can be realized in embodiments such as a method and a device or printing system for minimizing uneven usage; an integrated circuit or a computer program for realizing the functions of such a method or device; or a recording medium with the computer program recorded thereon.

### BRIEF DESCRIPTION OF THE DRAWINGS

Referring now to the attached drawings which form a part of this original disclosure:

FIG. 1 is a descriptive diagram illustrating a configuration of a printing device 10 according to a first working example;

FIG. 2 is a descriptive diagram showing in model form a configuration of a print head 50 in the printing device 10;

FIG. 3 is a descriptive diagram illustrating an arrangement for supplying ink;

FIG. 4 is a flowchart showing the flow of a printing process carried out by the printing device 10;

FIG. 5 is a descriptive diagram illustrating an ejection nozzle determination table M2;

FIG. 6 is a descriptive diagram illustrating the ejection nozzle determination table M2 used in the first working example;

FIG. 7 is a descriptive diagram illustrating a matrix MT;

FIG. 8 is a descriptive diagram illustrating effects in the first working example;

FIG. 9 is a descriptive diagram illustrating a first modification example;

FIG. 10 is a descriptive diagram illustrating a first mode in a second modification example;

FIG. 11 is a descriptive diagram illustrating a second mode in the second modification example;

FIG. 12 is a descriptive diagram illustrating a third mode in the second modification example;

FIG. 13 is a descriptive diagram illustrating a matrix Mta in a third modification example; and

FIG. 14 is a descriptive diagram illustrating a matrix Mtb in the third modification example.

### DETAILED DESCRIPTION OF EXEMPLARY EMBODIMENTS

The embodiments of the invention are described next on the basis of working examples.

### A. First Working Example

### (A1) Configuration of Printing Device

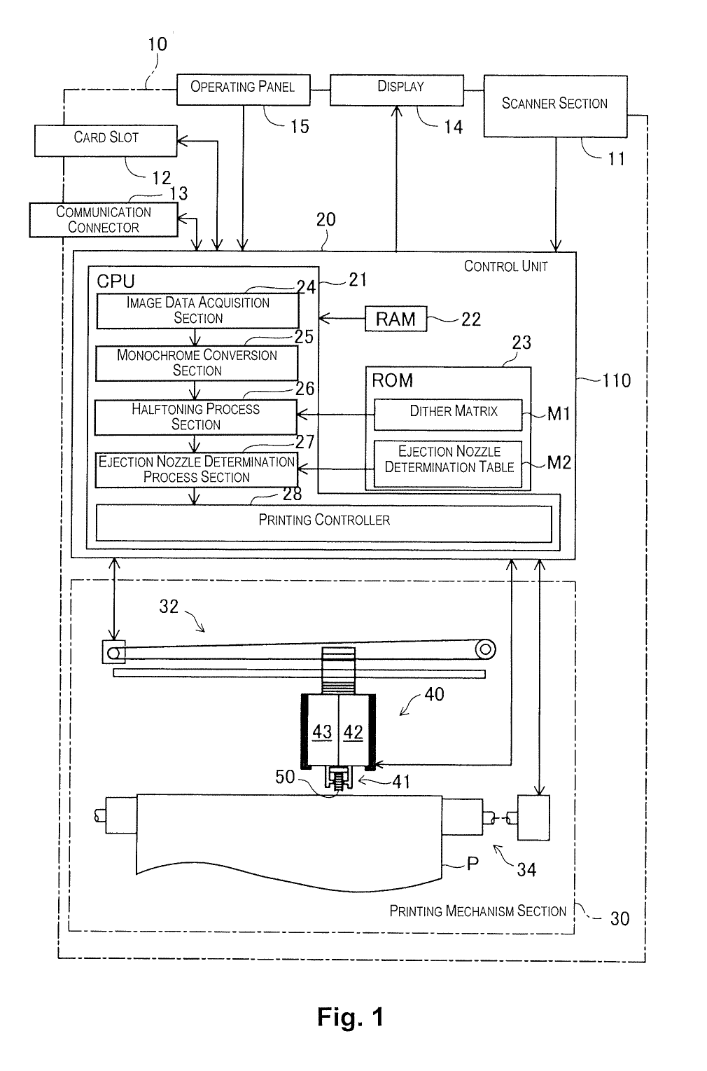

FIG. 1 is a descriptive diagram illustrating a configuration of a printing device 10 according to a first working example. The printing device 10 is an inkjet printer for ejecting ink onto a printing medium P on the basis of image data in order to print out text, images, and the like. In the present working example, the printing device 10 is a “multifunction unit” having various functions such as scanner and copy functions. As will be discussed later, the printing device 10 is a dedicated printing device for monochrome printing using black ink only.

The printing device 10 is provided with a card slot 12 and a communication connector 13. The card slot 12 of the printing device 10 is an interface for connection to a memory card housing a storage medium, for data exchange therewith. The communication connector 13 of the printing device 10 is an interface for connection with a PC, digital camera, digital video camera, or other external equipment, for data exchange therewith. The printing device 10 has a function of printing based on a print request from external equipment connected to the communication connector 13, as well as a function of printing image data stored in a memory card connected to the card slot 12, or in external equipment connected to the communication connector 13.

The printing device 10 is further provided with a scanner section 11, a display 14, and an operating panel 15. The scanner section 11 scans an original document which has been placed on an original document bed, and converts it to digital data. The display 14 displays text and images to a user. The operating panel 15 receives command inputs from the user.

In addition to the above-described card slot 12 and the communication connector 13, the printing device 10 is further provided with a control unit 20 for controlling the sections of the printing device 10, and a printing mechanism section 30 for executing printing of the printing medium P.

The control unit 20 includes a CPU 21, a RAM 22, and a ROM 23. The CPU 21 is provided with an image data acquisition section 24, a monochrome conversion section 25, a halftoning process section 26, an ejection nozzle determination process section 27, and a printing controller 28. The image data acquisition section 24 acquires image data from the scanner section 11, the card slot 12, or the communication connector 13. In cases where the acquired image data is RGB image data, the monochrome conversion section 25 performs data conversion to monochrome image data. The halftoning process section 26 performs a process to convert image data to a distribution of dots, based on the tones of the monochrome-converted image data. A dither matrix M1 stored in the ROM 23 is used in the halftoning process. Using an ejection nozzle determination table M2 stored in the ROM 23, the ejection nozzle determination process section 27 determines, for each dot of the image data from the halftoning process, which of the nozzles provided to a print head 50, discussed later, is to be used to eject ink to form the dot on the printing medium P. The printing controller 28 controls the operation of the printing mechanism section 30 on the basis of the processed data from the ejection nozzle determination process section 27. The above-described processes are realized through loading and execution by the CPU 21 of a program stored in the ROM 23. The dither matrix M1 and the ejection nozzle determination table M2 are stored in the ROM 23 in advance.

As shown in FIG. 1, the printing mechanism section 30 of the printing device 10 is provided with a carriage 40, a head unit 41, a carriage drive section 32, and a conveying section 34. The carriage drive section 32 drives the carriage 40 in a main scanning (head scanning) direction. The conveying section 34 conveys the printing medium P in a sub-scanning direction intersecting the main scanning direction in which the carriage 40 moves.

The carriage 40 retains the head unit 41, as well as carrying an ink cartridge 42 and an ink cartridge 43. The ink cartridges 42, 43 carried on the carriage 40 function as a liquid supply section for supplying ink to the head unit 41. Both of the ink cartridges 42, 43 contain black (BK) ink. In the present working example, printing is carried out as monochrome printing with a single color of black ink; however, for example, the ink cartridges 42, 43 may contain ink of any one color, for example, sepia color, or red, blue, magenta (M), cyan (C), or the like, and printing may be carried out with a single color of magenta, cyan, or the like. Also, the two ink cartridges may contain inks of the same hue, such as where the ink cartridge 42 contains black (BK), and the ink cartridge 43 contains light black (LK), or the like.

The head unit 41 is provided with a print head 50. The print head 50 is provided with a plurality of nozzles for ejecting black (BK) ink. Printing of the printing medium P is realized through cooperation among the sections of the print head 50, the carriage drive section 32, and the conveying section 34, on the basis of control by the control unit 20.

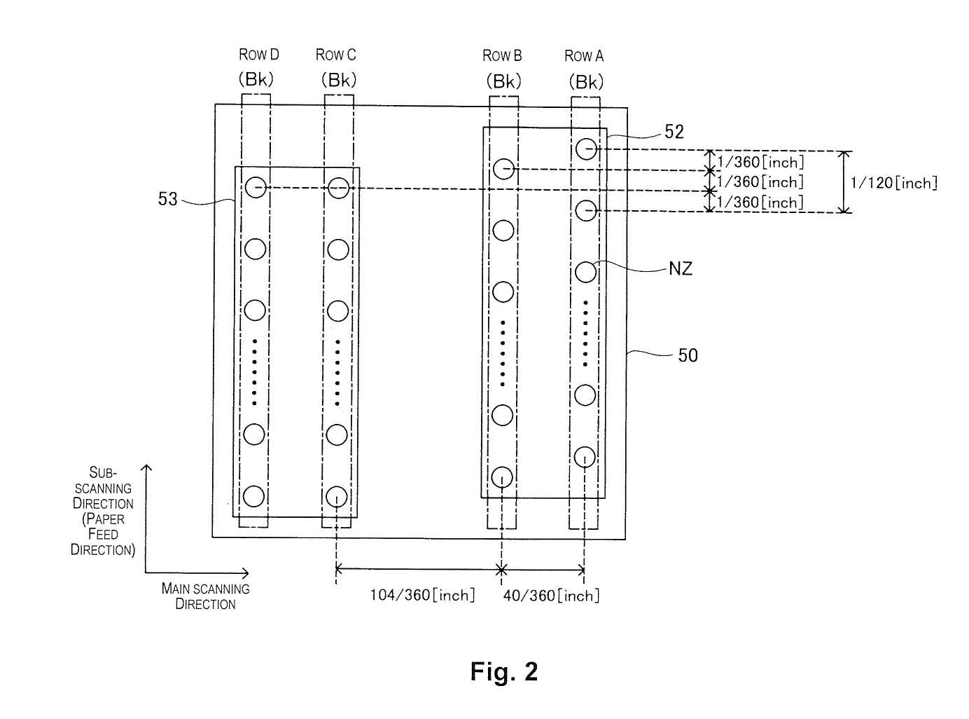

FIG. 2 is a descriptive diagram showing in model form the configuration of the print head 50 in the printing device 10. The print head 50 is provided with a plurality of nozzle rows containing a plurality of nozzles NZ for ejecting ink (black in the present working example) lined up in the sub-scanning direction (i.e., the paper feed direction).

In the present working example, the print head 50 is provided with four nozzle rows, row A, row B, row C, and row D, which have a plurality of nozzles NX arrayed in the sub-scanning direction (more specifically, the paper feed direction). As shown in FIG. 2, these four nozzle rows are arranged in parallel in the main scanning direction. Row A and row B are set apart by a gap of 40/360 (inch) in the main scanning direction. Likewise, row C and row D are set apart by a gap of 40/360 (inch) in the main scanning direction. Row B and row C are set apart by a gap of 104/360 (inch) in the main scanning direction.

128 of the nozzles NZ are arrayed in the sub-scanning direction in each of the nozzle rows of row A, row B, row C, and row D. Within each nozzle row, the gap between nozzles NZ in the sub-scanning direction (hereinafter also termed “nozzle pitch”) is 1/120 (inch). With the nozzle row of row A as a reference point, the position of row B in the print head 50 is arranged at a position shifted by 1/360 (inch) in the sub-scanning direction. With the nozzle row of row B as a reference point, the position of row C in the print head 50 is arranged at a position shifted by 1/360 (inch) in the sub-scanning direction. The position of row D in the print head 50 is arranged at the same position as the nozzle row of row C in the sub-scanning direction. Consequently, by carrying out printing through scanning of the print head 50 in the main scanning direction, printing is carried out in a manner substantially similar to that of a print head of a configuration with a nozzle pitch of 1/360 (inch). The nozzle rows of row C and row D correspond to the first nozzle group disclosed in the Claims, and the nozzle rows of row A and row B correspond to the second nozzle group disclosed in the Claims.

The plurality of nozzles NZ are individually provided with piezo elements (piezoelectric elements), and in association with the application of a voltage to the piezo elements, ink is ejected from the nozzles NZ through oscillation induced by deformation of the piezo elements. Consequently, in addition to the piezo elements discussed above, the nozzles NZ are individually provided with electrodes for applying voltage, and with other elements necessary for ejection of ink. In the present working example, during manufacture of the print head 50, a nozzle unit 52 provided with the nozzle rows of row A and row B, and a nozzle unit 53 provided with the nozzle rows of row C and row D, are manufactured individually, then the nozzle unit 52 and the nozzle unit 53 are assembled into the print head 50 main unit.

Specifically, the nozzle unit 52 (or the nozzle unit 53) is manufactured using a substrate having through-holes at positions of the nozzles NZ of row A and row B (or row C and row D). During manufacture of the nozzle units, a substrate material from which a plurality of substrates for use as nozzle units may be cut is used. Through-holes which will become the nozzles are opened at every one of the positions of the substrate material which will become the nozzle units, and installation of piezo elements in the through-holes and printing of the electrodes are carried out. The substrate material having passed through these steps is then cut into nozzle units to manufacture the nozzle units. Specifically, in the case of the present working example, the nozzles NZ provided in row A and row B are manufactured in the same series of manufacturing steps. Likewise, the nozzles NZ provided in row C and row D are manufactured in the same series of manufacturing steps. In other words, row A and row B have a nozzle unit in common, and row C and row D have a nozzle unit in common.

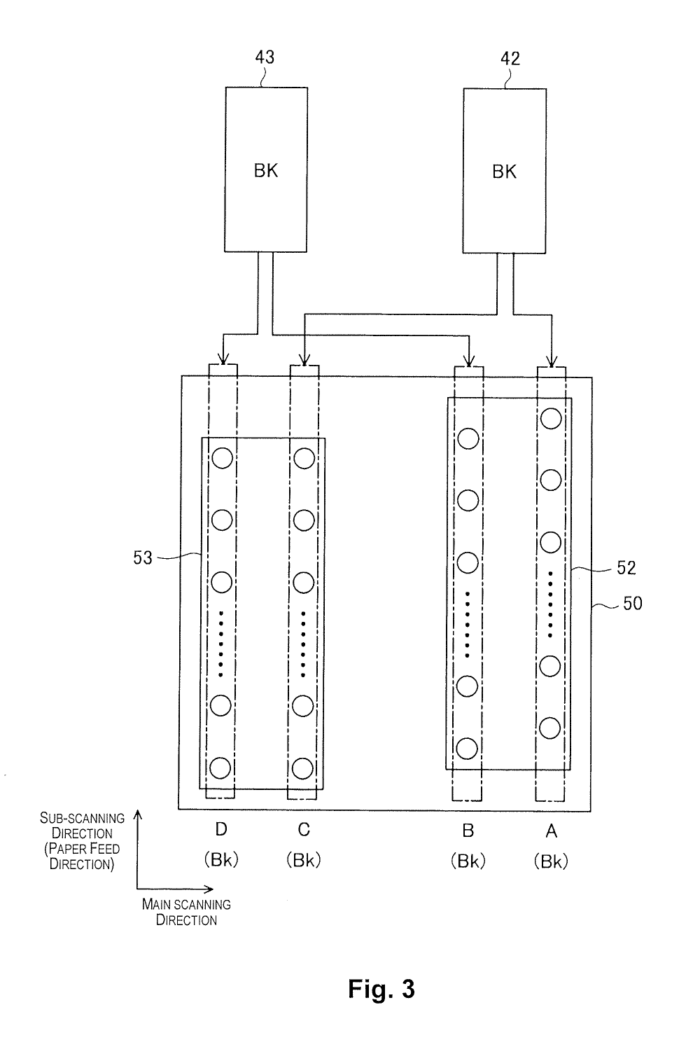

Next, the arrangement for supplying ink from the ink cartridges 42, 43 to the nozzle NZ is described using FIG. 3. The ink cartridge 42 supplies ink to the nozzles NZ of row A and to the nozzles NZ of row C. The ink cartridge 43 supplies ink to the nozzles NZ of row B and to the nozzles NZ of row D. More specifically, each of the two nozzle units 52, 53 provided to the print head 50 ink is respectively supplied with ink from one cartridge. In other words, every or of the ink cartridges supplies the nozzle units with ink for the nozzle rows thereof in one-row sets. Specifically, as shown in FIG. 3, the nozzle unit 52 is supplied with ink from the ink cartridge 42 for the equivalent of one row, i.e., the nozzle row of row A, and is supplied with ink from the ink cartridge 43 for the equivalent of one row, i.e., the nozzle row of row C. Consequently, there is no limitation to the mode of ink supply taught in the present working example, and a mode whereby, for example, the ink cartridge 42 supplies ink to the nozzles NZ of row B and to the nozzles NZ of row C, while the ink cartridge 43 supplies ink to the nozzles NZ of row A and the nozzles NZ of row D, is also acceptable.

### (A2) Printing Process

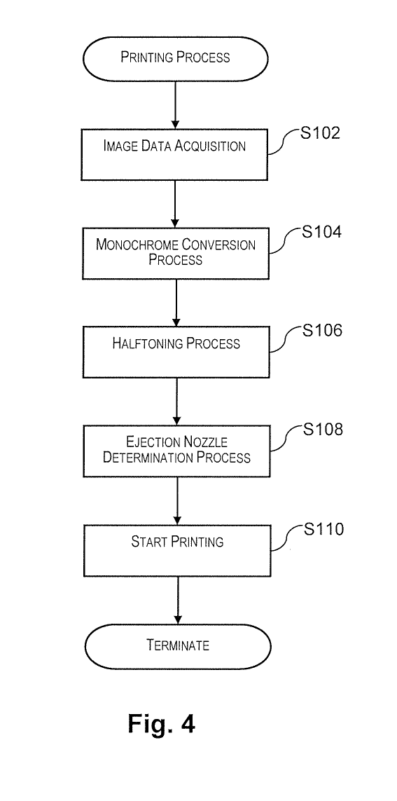

Next, the printing process carried out by the printing device 10 is described. FIG. 4 is a flowchart showing the flow of the printing process carried out by the printing device 10. When the printing process starts, the CPU 21 acquires image data through the scanner section 11, the card slot 12, or the communication connector 13 (Step S102). In a case where the acquired image data is RGB image data, the image data is converted to monochrome data (Step S104). For example, conversion to monochrome image data is effected through conversion to tone values of black (K) using a three-dimensional lookup table for color conversion composed of R, G, and B elements.

After the conversion to monochrome image data, the CPU 21 carries out a halftoning process on the monochrome image data (Step S106). Specifically, using the dither matrix M stored in the ROM 23, the tone values of the pixels of the monochrome image data are converted to binary data. More specifically, tone data is converted to dot data by determining whether or not to form a dot on each pixel of the image data. In the present working example, a known ordered dither method is used as the halftoning process. Besides an ordered dither method, an error diffusion method, a density pattern method, or other halftoning technique can be utilized as the halftoning process. Because these halftoning techniques are known techniques, description is omitted.

Subsequently, the CPU 21 carries out an ejection nozzle determination process on the image data from the halftoning process (Step S108). As discussed previously, the ejection nozzle determination process is a process for determining, for each dot of the dot data from the halftoning process, from which nozzle to eject ink to form the dot on the printing medium. While the ejection nozzle determination process is being carried out, the CPU 21 uses the ejection nozzle determination table M2 saved in the ROM 23. The ejection nozzle determination table M2 is described below.

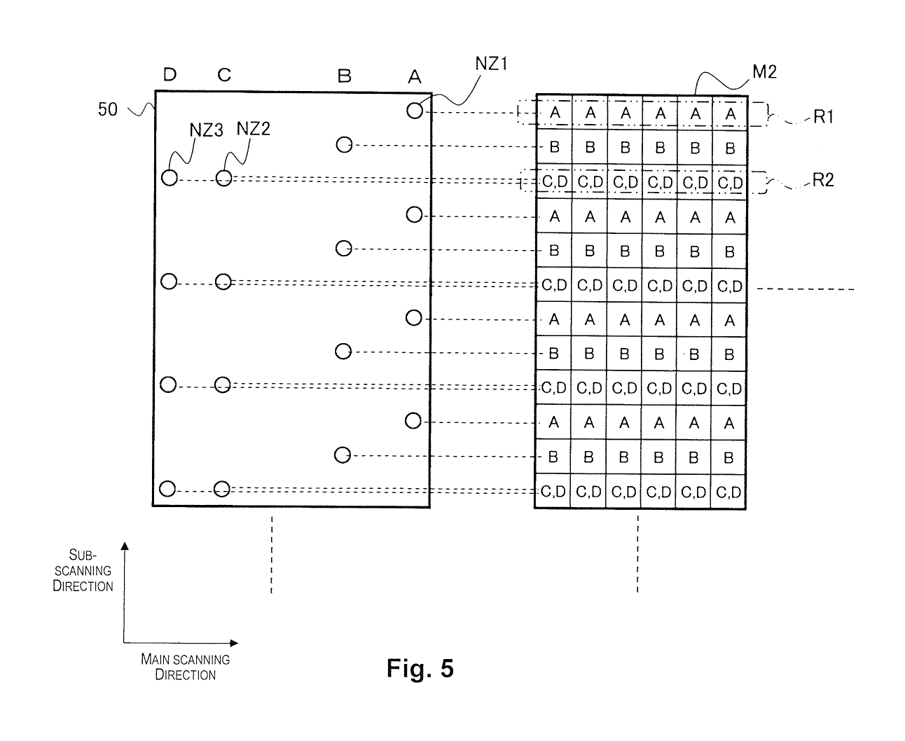

FIG. 5 is a descriptive diagram illustrating the ejection nozzle determination table M2. The print head 50 and the ejection nozzle determination table M2 are shown in FIG. 5. The cells of the matrix of the ejection nozzle determination table M2 correspond to pixels of image data. The letters A, B, C, and D disclosed inside the cells show to which nozzle rows the nozzles ejecting the ink belongs (see FIG. 2). For example, for dots in dot data corresponding to cells disclosing “A”, printing is carried out by ejecting ink from nozzles of row A. Where “C, D” are disclosed in a single cell, printing is carried out by ejecting ink from nozzles belonging to nozzle rows of either row C or row D.

In the printing process of the present working example, raster lines in a printed image are printed in the course of a single main scan of the print head 50. For example, the raster line R1 in which cells disclosing “A” line up in the main scanning direction as shown in the ejection nozzle determination table M2 of FIG. 5 is made up of ink dots formed on the printing medium P in the course of a single main scan (herein, a main scan of the print head in the printing process is also termed a “pass”) of the print head 50 while ejecting ink from nozzles NZ1 belonging to row A shown on the print head 50. Meanwhile, the raster line R2 in which cells disclosing “C, D” in the main scanning direction as shown in the ejection nozzle determination table M2 is made up of dots of ink formed on the printing medium in the course of a single pass of the print head 50 while ejecting ink from either nozzles NZ2 or nozzles NZ3 belonging to row C or row D shown on the print head 50.

The table shown in FIG. 6 is employed as the ejection nozzle determination table M2 in the present working example. In order for the mode of array of “C” and “D” in the ejection nozzle determination table M2 to be readily visible in FIG. 6, cells pertaining to “C” are shown with hatching. Herein, cells showing that ink is to be ejected from the nozzle row of row C (or row D) to form a dot are sometimes simply disclosed as “C” (or “D”).

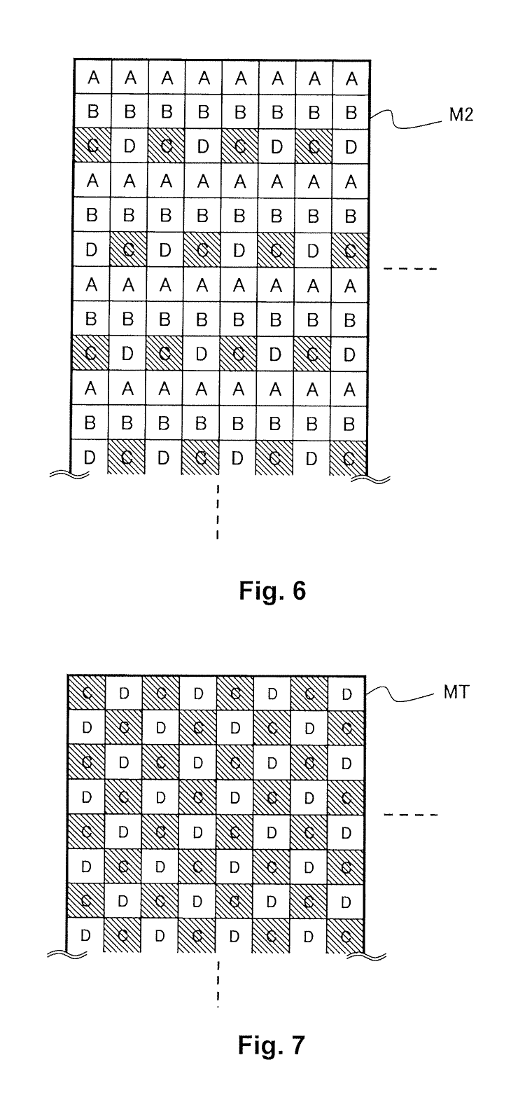

FIG. 7 is a descriptive diagram illustrating characteristics of the ejection nozzle determination table M2 shown in FIG. 6. FIG. 7 shows a matrix MT which is a matrix representation obtained by extraction of “C” and “D” disposed in the ejection nozzle determination table M2 of FIG. 6. In the matrix MT, “C” and “D” are arrayed in a checkerboard pattern. The matrix MT shown in FIG. 7 has the following four characteristics.

Characteristic (1): Both “C” and “D” are present in each raster line in the matrix MT.

Characteristic (2): In the matrix MT as a whole, the number of “C” and the number of “D” are the same or nearly the same.

Characteristic (3): “C” and “D” respectively have approximately uniform dispersion throughout the matrix MT as a whole.

Characteristic (4): In each raster line of the matrix MT, the number of “C” and the number of “D” are the same or nearly the same.

“Approximately uniform dispersion” as referred to in characteristic (3) means that, for example, the dispersion is one whose spatial frequency characteristics in the pattern for disposing “C” (or “D”) in the matrix MT have blue noise characteristics. More specifically, the distribution is one established in consideration of human visual characteristics, whereby in consideration of the human visual characteristic of low sensitivity in the high-frequency area, “C” (or “D”) is disposed such that the greatest frequency component is generated in the high-frequency area. The determination as to what sort of characteristics to give the matrix MT is made in the printing device 10 manufacturing stage, and is stored in the ROM 23 of the printing device 10 in the mode of the ejection nozzle determination table M2 shown in FIG. 6.

In the ejection nozzle determination process (FIG. 4: Step S108), the above-described ejection nozzle determination table M2 is applied to the pixels of the dot data, to determine which nozzles should eject ink to form the dots in the dot data. In actual processing, data corresponding to the ejection nozzle determination table M2 is appended to the pixel data in the dot data.

Subsequently, on the basis of the image data from the ejection nozzle determination process, the CPU 21 starts printing (Step S110). Once printing starts, the CPU 21, in a process performed by the printing controller 28, controls the printing mechanism section 30 on the basis of the image data from the ejection nozzle determination process, to scan the print head 50, eject ink from the nozzles NZ, etc., to print a printed image onto the printing medium P. Then, in association with termination of printing of the printed image onto the printing medium P, the CPU 21 terminates the printing process.

As described above, the print head 50 provided to the printing device 10 is supplied with ink from the ink cartridges by the arrangement shown in FIG. 3. More specifically, in each of the nozzle units, ink is supplied to the same number of nozzle rows thereof, by every ink cartridge. Consequently, in cases where image data based on typical natural images, more specifically, image data with a minimum of extreme bias of tone within the area of the printed image, is processed by the printing device 10, uneven usage of ink can be efficiently minimized.

Further, in the present working example, because the matrix MT has characteristic (2), and the printing process is carried out using the ejection nozzle determination table M2, the ink contained in the ink cartridge 42 and the ink contained in the ink cartridge 43 can be consumed in an approximately uniform manner. In other words, biased depletion (uneven usage) of ink between ink cartridges can be minimized.

The effect of this minimization of uneven usage shall next be described in specific terms. For example, in cases where a printing process is carried out using the ejection nozzle determination table M2 described in FIG. 6, dots based on row A and dots based on row B are present in substantially equal number. Further, owing to the aforedescribed characteristic (2), dots based on row C and dots based on row D are present in substantially equal number. Consequently, the total number of dots based on row A and row C, and the total number of dots based on row B and row D, are approximately the same within the ejection nozzle determination table M2. Therefore, consumption of ink from the ink cartridge 42 which supplies ink to the nozzles of row A and row C, and from the ink cartridge 43 which supplies ink to the nozzles of row B and row D, will be approximately uniform throughout the printing process in the present working example. This effect is particularly effective for image data based on typical natural images, more specifically, image data with a minimum of extreme bias of tone within the area of the printed image.

Also, as discussed above, in the nozzle rows provided to the print head 50, row A and row B have a nozzle unit in common, and row C and row D have a nozzle unit in common. More specifically, the nozzle row of row A and the nozzle row of row B are formed on the same substrate, and are manufactured through the same manufacturing steps. Likewise, the nozzle row of row C and the nozzle row of row D are formed on the same substrate, and are manufactured through the same manufacturing steps. There are cases in which ink ejection characteristics from nozzles NZ (ink ejection amount, ink ejection speed, and the like) differ among every nozzle unit, for a cause relating to the manufacturing steps. In some cases, the substrate material may have differences in crystalline structure and in attendant physical properties depending on position therein, and in some cases these differences may be expressed as differences in ink ejection characteristics of every nozzle unit. Because the nozzle row of row A and the nozzle row of row B have a nozzle unit in common, differences in ink ejection characteristics (particularly ink ejection amount) do not arise within the nozzle unit. Likewise, differences in ink ejection characteristics between the nozzle row of row C and the nozzle row of row D do not arise within the nozzle unit. Consequently, in cases where the printing process is carried out in the present working example, the amount of ink consumption consumed in the printing process by the nozzle rows of row A and row C, and the amount of ink consumption consumed in the printing process by the nozzle rows of row B and row D, further approach equality. More specifically, uneven usage of ink can be minimized further.

As a first effect thereof, in the printing process, the printing device 10 carries out the ejection nozzle determination process using the ejection nozzle determination table M2 described in FIG. 6. The ejection nozzle determination table M2 described in FIG. 6 is generated on the basis of the matrix MT having the above-described characteristics (1), (2), (3), and (4). The matrix MT in the present working example has “Characteristic (1): Both “C” and “D” are present in each raster line in the matrix MT.” Consequently, even in a case where the print head 50 is seated in the printing device 10 in an inclined state due to some outside action during the manufacturing steps or after manufacture, conspicuous localized density of dot placement (banding) occurring due to inclination of the print head can be minimized. A specific description follows.

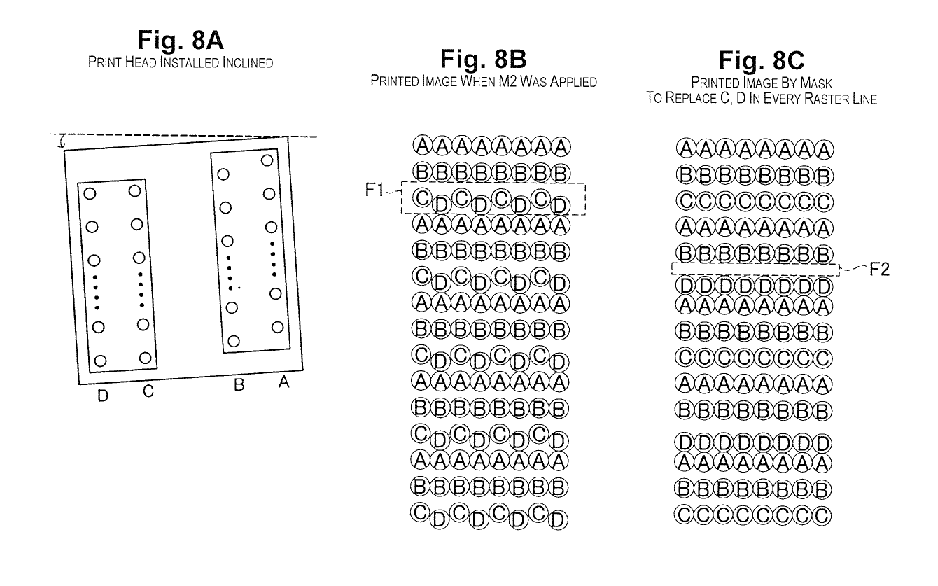

FIG. 8 is a descriptive diagram illustrating effects of the ejection nozzle determination process using the ejection nozzle determination table M2, in a case where printing has been carried out with the print head 50 in an inclined state. FIG. 8A shows the print head 50 in an inclined state. As shown in FIG. 8A, the print head 50 is inclined in a direction of rotation within a plane defined by the main scanning direction and the sub-scanning direction. In a case where printing has been carried out with this print head 50, because according to the ejection nozzle determination process in the present working example, the raster lines are printed in the course of a single main scan of the print head 50 using the ejection nozzle determination table M2 based on the matrix MT having the aforedescribed characteristic (1) and characteristic (4), dots of ink ejected from nozzles belonging to row C and dots of ink ejected from nozzles belonging to row D are dispersed and intermixed in the main scanning direction on raster lines in which banding occurs.

Furthermore, because the print head 50 is inclined, dots based on row C and dots based on row D are formed with the dot formation positions thereof shifted in the sub-scanning direction. Consequently, as shown by area F1 of FIG. 8B, in areas where banding occurs due to inclination of the print head 50, dots based on row C and dots based on row D are dispersed in the sub-scanning direction. Therefore, conspicuous banding caused by inclination of the print head 50 is minimized.

As a comparative example, in a case where an ejection nozzle determination process was carried out using an ejection nozzle determination table M2 based on a matrix MT of a mode in which, for example, “C” and “D” are replaced in every raster line, and printing was carried out, banding of considerable width in the sub-scanning direction occurred between raster lines of dots based on nozzles of row B, and raster lines of dots based on nozzles of row D, as shown in FIG. 8 (C). Further, in the areas of banding, dots were not dispersed in the sub-scanning direction as in FIG. 8B, and therefore banding was conspicuous.

As will be appreciated by comparison with the aforedescribed comparative example, conspicuous banding due to inclination of the print head can be minimized by a matrix MT having the aforedescribed characteristic (1) and characteristic (3). Also, owing to the aforedescribed characteristic (3), dots based on row C and dots based on row D can be dispersed approximately uniformly throughout the entire printed image. Therefore, shifts of dot positions of row C and row D in the sub-scanning direction due to inclination of the print head 50 can be dispersed overall, and visual conspicuousness of this shifting can be minimized further.

As another second effect, on the print head 50 provided to the printing device 10, the nozzles rows of row A, row B, row C, and row D whose nozzle pitch is 1/120 (inch) are arranged at shifted positions in the sub-scanning direction in a predetermined mode (see FIG. 2). Therefore, through printing by scanning the print head 50 configured in this way, printing can be carried out in a manner substantially similar to a print head configured with a nozzle pitch of 1/360 (inch). In order to obtain this effect, the present working example is configured such that row A, row B, and row C are uniformly shifted in sets of 1/360 (inch), but there is no limitation thereto, and a configuration in which row A, row B, and row C are shifted by any width in the sub-scanning direction within a permissible range given the configuration of the print head 50 is acceptable. Also, in the present working example, the nozzle pitch in the nozzle rows is 1/120 (inch) and uniform, but there is no limitation thereto, and any nozzle pitch is possible within a permissible range given the configuration of the print head 50.

Elements corresponding with the Claims are as follows: the carriage drive section 32 and the conveying section 34 correspond to the head-moving section disclosed in the Claims; the CPU 21 corresponds to the controller disclosed in the Claims; the nozzle row of row C and the nozzle row of row D correspond to the first nozzle group disclosed in the Claims; and the nozzle row of row A and the nozzle row of row B correspond to the second nozzle group disclosed in the Claims.

### B. Modification Examples

The aforedescribed working example should not be construed as limiting this invention, and various modes of working the invention are possible without departing from the spirit thereof, with modifications such as the following being possible, for example.

### (B1) Modification Example 1

In the printing process of the aforedescribed working example, raster lines in the printed image are printed in one pass, but there is no limitation thereto, and raster lines may be printed in N (N is an integer of 2 or greater) passes of the print head 50. Such printing is termed “overlap printing in N passes,” and N is referred to as the “overlap number.” By carrying out the printing process through overlap printing, shifting of the landing position of ink due to inclination of the print head as discussed previously or to errors in the amount of paper feed, and banding arising from such shifting, does not readily become conspicuous, and image quality can be improved.

Further, while carrying out overlap printing, by scanning the amount of paper feed (more specifically, the scan amount of the print head 50 in the sub-scanning direction relative to the printing medium P), in units of 1/720 (inch) and by using an interlacing process, printing can be carried out at a resolution of 720 (dpi). Printing techniques using interlacing processes are known in the art, and therefore a description is omitted.

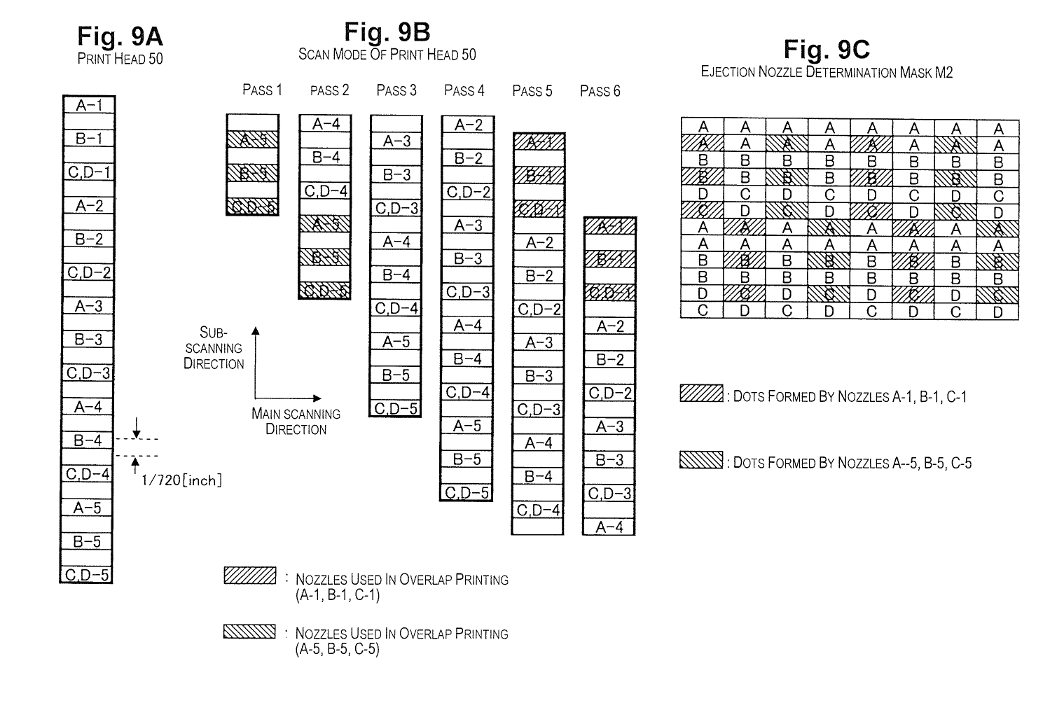

A specific example is described by FIG. 9. FIG. 9 is a descriptive diagram illustrating a first modification example. In the present specific example, a printing process is carried out by using the ejection nozzle determination table M2 shown in FIG. 9 (C). In the ejection nozzle determination table M2 of FIG. 9 (C), the raster lines of “A,” “B,” and “C, D” of the ejection nozzle determination table M2 shown in FIG. 5 are respectively arrayed in two-tier sets. There is 1/720 (inch) between the raster lines.

FIG. 9A and FIG. 9B are explanatory diagrams describing overlap printing carried out in accordance with the ejection nozzle determination table M2 of FIG. 9C, while adjusting the amount of paper feed in units of 1/720 (inch). For convenience in description, FIG. 9A shows the print head 50 as a nozzle row depicted in cursory form. As discussed previously, because the print head 50 can be viewed as having a configuration substantially similar to a print head with a 1/360 (inch) configuration, a representation like the print head 50 of FIG. 9A is possible. As for the letters A to D inside the print head 50, the nozzles actually belong to the nozzle rows shown by the letters. The numbers 1 to 5 inside the print head 50 show nozzle numbering in the sub-scanning direction of the nozzle rows. For example, “A-3” shows that the nozzle is the third one in the sub-scanning direction of the nozzle row of row A.

FIG. 9B is a descriptive diagram of the scanning mode of the print head 50 in the sub-scanning direction, more specifically, of the mode of paper feed of every pass, represented with the print head 50 at the center. In the ejection nozzle determination table M2 of FIG. 9C, dots without hatching are dots formed in a single pass in which the dots are formable, from among the first to sixth passes. As shown in FIGS. 9B and C, dots with hatching in FIG. 9C are dots formed by ejection of ink from specific nozzles during passes. By carrying out the printing process in this manner, all of the raster lines can be printed in a plurality of passes (herein also referred to as “full overlap (FOL).” Through the use of FOL, resolution in the main scanning direction can be improved in the printing process.

Further, it is possible for full overlap printing in this manner to be carried out by only some of the nozzles of the print head 50. In the case of the present modification example, overlap printing is carried out using “A-1,” “B-1,” “C, D-1,” “A-5,” “B-5,” and “C, D-5” of the print head 50. By carrying out overlap printing through partial nozzle coverage in this manner, it is possible to ensure an ample amount of paper feed, and printing speed can be improved when carrying out overlap printing. Also, because printing is carried out using an interlacing process described above, resolution in the main scanning direction can be improved in the printing process (in the present modification example, to 720 (dpi)).

### (B2) Modification Example 2

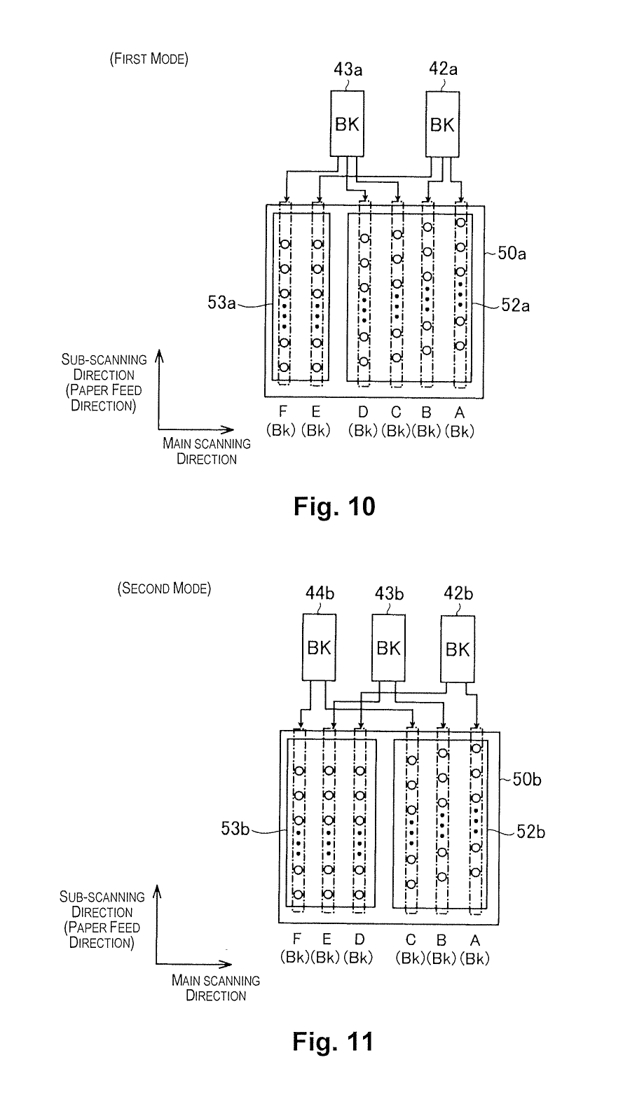

In the preceding working example, the print head 50 and the arrangement for supplying ink assume the modes shown in FIGS. 2 and 3, but such a configuration is not provided by way of limitation; other configurations of the print head and the arrangements for supplying ink may be adopted instead. Examples are shown in FIGS. 10 to 12. In a first mode shown in FIG. 10, a nozzle unit 52a is provided with four nozzle rows. Of the four nozzle rows of the nozzle unit 52a, two rows are supplied with ink from an ink cartridge 42a, while the remaining two rows are supplied with ink from an ink cartridge 43a. More specifically, sets of two rows among the nozzle rows are respectively supplied with ink from different ink cartridges. Meanwhile, a nozzle unit 53a is provided with two nozzle rows. Of the two nozzle rows of the nozzle unit 53a, one row is supplied with ink from the ink cartridge 42a, while the remaining one row is supplied with ink from the ink cartridge 43a. By adopting this first mode, it is possible to efficiently minimize uneven usage of ink.

FIG. 11 depicts a second mode with yet another configuration of the print head and arrangement for supplying ink. As will be appreciated from FIG. 11, individual rows among the nozzle rows of a nozzle unit 52b are respectively supplied with ink from different ink cartridges 42b, 43b, 44b. Like the nozzle unit 52b, in the nozzle unit 53b, individual rows among the nozzle rows are respectively supplied with ink from different ink cartridges 42b, 43b, 44b. By adopting this second mode, it is possible to efficiently minimize uneven usage of ink.

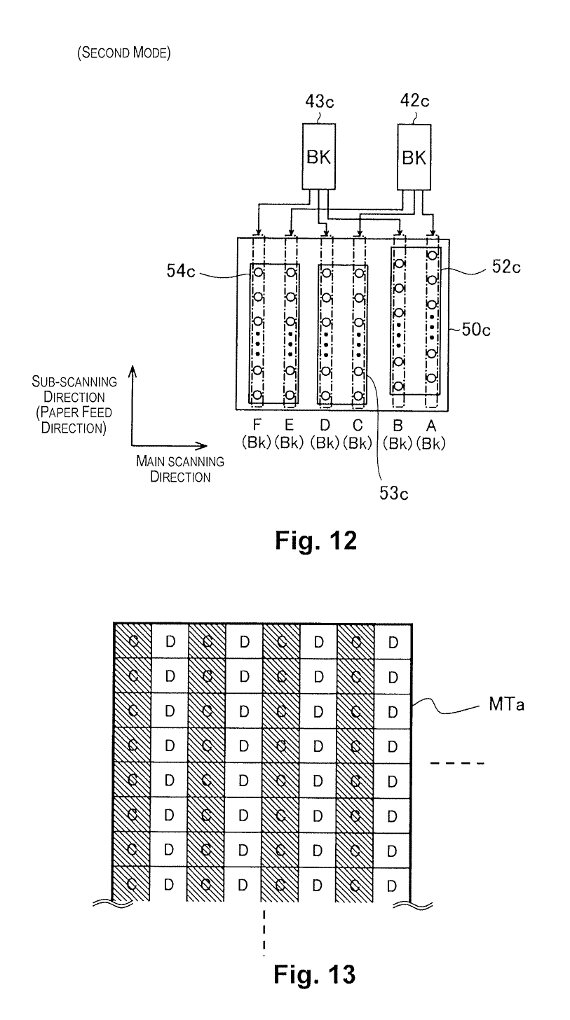

FIG. 12 depicts a third mode. The configuration in this mode is provided with two nozzle units corresponding to the first nozzle group disclosed in the Claims. As will be appreciated from FIG. 12, individual rows among the nozzle rows of nozzle units 52c, 53c, 54c are respectively supplied with ink from different ink cartridges 42c, 43c. By adopting this third mode, it is possible to efficiently minimize uneven usage of ink.

As will be appreciated from the first, second, and third modes shown in the present modification examples, where the number of ink cartridges provided to a printing device is designated as L (L being an integer of 2 or greater), a nozzle group (e.g., the nozzle unit 53a) provided with L×a nozzle rows (a being an integer of 1 or greater) of nozzles with mutually the same position in the sub-scanning direction is supplied with ink from ink cartridges in sets of a rows. This nozzle group corresponds to the first nozzle group disclosed in the Claims. Also, a nozzle group (e.g., the nozzle unit 53a) provided with L×b nozzle rows (b being an integer of 1 or greater) in which the positions of the nozzles in the sub-scanning direction differ from those of the aforedescribed L×a nozzle rows is supplied with ink from ink cartridges in sets of b rows. This nozzle group corresponds to the second nozzle group disclosed in the Claims. By adopting a configuration of the print head and an arrangement for supplying ink based on this mode, uneven usage of ink can be minimized.

As the printing process in the case of modes such as these, in the case of the third mode of FIG. 11 for example, row A, row B, and row C are arranged at positions shifted by 1/360 (inch) from one another in the sub-scanning direction, and in row C, row D, row E, and row F, the positions of the nozzles of the nozzle rows in the sub-scanning direction are mutually the same. In the case of a print head 50c, as one example, a printing process is possible through adoption of a matrix MT having characteristics in which “C,” “D,” “E,” and “F” have been substituted for “C” and “D” in characteristic (1) to characteristic (4) discussed in the first working example.

More specifically, the process is realizable by virtue of having the following characteristics:

Characteristic (1): “C,” “D,” “E,” and “F” are present in each raster line in the matrix MT.

Characteristic (2): In the matrix MT as a whole, the numbers of “C,” “D,” “E,” and “F” are the same or nearly the same.

Characteristic (3): “C,” “D,” “E,” and “F” respectively have approximately uniform dispersion throughout the matrix MT as a whole.

Characteristic (4): In each raster line of the matrix MT, the numbers of “C,” “D,” “E,” and “F” are the same or nearly the same.

### (B3) Modification Example 3

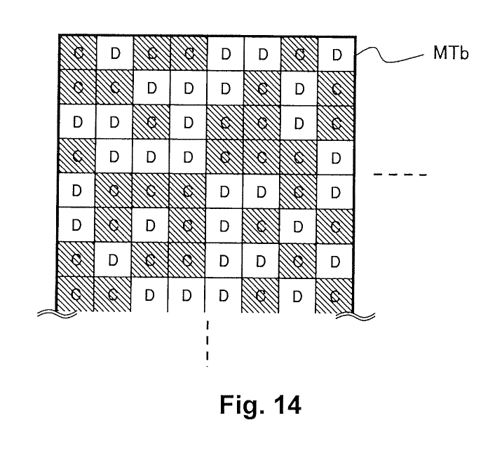

In the preceding working example, the matrix MT shown in FIG. 7 was adopted, but there is no limitation thereto; it is possible to use another matrix MT, provided that the numbers of “C” and “D” are approximately uniform throughout the matrix MT as a whole. For example, the matrix MTa shown in FIG. 13 or the matrix MTb shown in FIG. 14 could be adopted. Uneven usage can be minimized by adoption of such a matrix MT.

In the preceding working example, the matrix MT has every one of characteristics (1) to (4), but there is no limitation thereto, and it is possible to adopt a matrix MT having any characteristic or characteristics selected from characteristic (1) to characteristic (4), such as one having characteristic (1) only, or one having characteristic (4) only. By adopting such a matrix MT, uneven usage can be minimized. Also, conspicuous banding can be largely avoided.

### (B4) Modification Example 4

Whereas the preceding working example has described a case where the printing process is carried out by ink dots of a single size in the printing process, the printing device 10 may instead carry out a printing process involving selective printing of dots of a plurality of different sizes. For example, it is possible to selectively print ink dots of three sizes: a large dot, a medium dot, and a small dot. The determination of whether to eject a large, medium, or small ink dot can be made on the basis of tone values of pixels of the print data.

### (B5) Modification Example 5

Some of the functions realized through software in the preceding working example may instead be realized through hardware, or some of the functions realized through hardware may instead be realized through software. Alternatively, some of the functions realized through software may instead be provided to an external device (for example, a computer) connected to the printing device 10. Whereas the preceding working example has described the printing device 10 as being a multifunction unit provided with a scanner, a copier, and the like, there is no limitation thereto; the printing device 10 may be a dedicated printing device for printing only. In this case, the printing process will be possible through acquisition of image data from a computer externally connected to the printing device 10. Further, whereas the printing device 10 is provided with black ink only by virtue of being a printing device exclusively for monochrome printing, color printing would be possible through separate provision of color inks.

What is claimed is:

1. A printing device for carrying out printing upon receiving a supply of ink from L ink cartridges (L being an integer of 2 or greater) in which ink of the same hue is accommodated, the printing device comprising:
a print head provided with a plurality of nozzle rows in which are arrayed, in a sub-scanning direction, a plurality of nozzles for ejecting the ink, the nozzle rows being spaced apart in a main scanning direction; and
a head-moving section for causing the print head to move in a relative manner with respect to a printing medium in the main scanning direction and in the sub-scanning direction;
the printing head includes a first nozzle group and a second nozzle group;
the first nozzle group having L×a nozzle rows (a being an integer of 1 or greater) in which the positions of the nozzles in the sub-scanning direction are mutually the same, and receives a supply of the ink from each of the L ink cartridges in sets of a rows; and
the second nozzle group having L×b nozzle rows (b being an integer of 1 or greater) in which the positions of the nozzles in the sub-scanning direction differ from those of the nozzles of the first nozzle group, and receiving a supply of the ink from each of the L ink cartridges in sets of b rows.

2. The printing device according to claim 1, wherein
the nozzle rows of the first nozzle group are integrally formed on a single substrate; and
the nozzle rows of the second nozzle group are integrally formed on a single substrate.

3. The printing device according to claim 1, wherein
the printing device is provided with a controller for controlling the scanning of the print head performed by the head-moving section and the ejection of ink from the nozzles; and
the first nozzle group has a predetermined correlation in printing through control by the controller.

4. The printing device according to claim 3, wherein
the controller carries out the control in such a manner that, of ink dots forming the entirety of a predetermined printed image,
the total number of ink dots formed of ink ejected by nozzles belonging to the first nozzle group is substantially equal for every nozzle row of the a rows; and
the total number of ink dots formed of ink ejected by nozzles belonging to the second nozzle group is substantially equal for every nozzle row of the b rows.

5. The printing device according to claim 3, wherein
the controller carries out the control in such a manner that, of ink dots forming at least part of a raster line that forms a predetermined printed image,
the total number of ink dots formed of ink ejected by nozzles belonging to the first nozzle group is substantially equal for every nozzle row of the a rows.

6. The printing device according to claim 1, wherein L=2, a=1, and b=1.

7. The printing device according to claim 1, wherein a nozzle pitch of the nozzle rows of the first nozzle group and a nozzle pitch of the nozzle rows of the second nozzle group are identical.

8. A print head provided with a plurality of nozzle rows in which are arrayed, in a sub-scanning direction, comprising:
a plurality of nozzles capable of ejecting ink of the same hue, the nozzle rows being spaced apart in a main scanning direction, wherein
the plurality of nozzle rows include a first nozzle group and a second nozzle group,
the first nozzle group having L×a nozzle rows (L being an integer of 2 or greater, and a being an integer of 1 or greater) in which the positions of the nozzles in the sub-scanning direction are mutually the same, and being capable of receiving a supply of the ink from each of the L ink cartridges in sets of a rows, and
the second nozzle group having L×b nozzle rows (b being an integer of 1 or greater) in which the positions of the nozzles in the sub-scanning direction differ from those of the nozzles of the first nozzle group, and being capable of receiving a supply of the ink from each of the L ink cartridges in sets of b rows.

9. The print head according to claim 8, wherein
the nozzle rows of the first nozzle group are integrally formed on a single substrate; and
the nozzle rows of the second nozzle group are integrally formed on a single substrate.

10. The print head according to claim 8, wherein
a nozzle pitch of the nozzle rows of the first nozzle group and a nozzle pitch of the nozzle rows of the second nozzle group are identical.

11. An ink cartridge of which L can be used (L being an integer of 2 or greater) in a printing device provided with a print head having a plurality of nozzle rows, wherein
ink is supplied to nozzle rows of a first nozzle group among the plurality of nozzle rows;
ink is supplied to nozzle rows of a second nozzle group among the plurality of nozzle rows;
the first nozzle group having L×a nozzle rows (a being an integer of 1 or greater) in which the positions of the nozzles in the sub-scanning direction are mutually the same, and receiving a supply of the ink from each of the L ink cartridges in sets of a rows; and
the second nozzle group having L×b nozzle rows (b being an integer of 1 or greater) in which the positions of the nozzles in the sub-scanning direction differ from those of the nozzles of the first nozzle group, and receiving a supply of the ink from each of the L ink cartridges in sets of b rows.

12. The ink cartridge according to claim 11, wherein
ink of the same hue is accommodated in the L ink cartridges.

13. The ink cartridge according to claim 11, wherein
the nozzle rows of the first nozzle group are integrally formed on a single substrate; and
the nozzle rows of the second nozzle group are integrally formed on a single substrate.

14. The ink cartridge according to claim 11, wherein
A nozzle pitch of the nozzle rows of the first nozzle group and a nozzle pitch of the nozzle rows of the second nozzle group are identical.
